(19) United States
(12) Patent Application Publication
(10) Pub. No.: US 2018/0359634 A1
(43) Pub. Date: Dec. 13, 2018

(54) WIRELESS COMMUNICATION SYSTEM, NON-TRANSITORY COMPUTER-READABLE MEDIUM STORING CONNECTION AUTHENTICATION PROGRAM, AND CONNECTION AUTHENTICATION METHOD

(71) Applicant: NEC Platforms, Ltd., Kawasaki-shi, Kanagawa (JP)

(72) Inventor: Takuya YAMAMOTO, Kanagawa (JP)

(73) Assignee: NEC Platforms, Ltd., Kawasaki-shi, Kanagawa (JP)

(21) Appl. No.: 15/527,771

(22) PCT Filed: Jul. 14, 2015
(86) PCT No.: PCT/JP2015/003539

§ 371 Date: May 18, 2017

(30) Foreign Application Priority Data
Nov. 25, 2014 (JP) 2014-237974

(51) Int. Cl. H04W 12/06; H04L 29/06; H04W 48/08

(52) U.S. Cl. CPC H04W 12/06; H04W 92/18; H04W 48/08; H04L 63/18

(57) ABSTRACT

A wireless communication system according to the present invention includes: a wireless master machine configured to control communication between a first network and a second network; a first wireless slave machine including third authentication information used for connection to a third network; and a second wireless slave machine including external information acquisition means for associating with the first network and acquiring the third authentication information. The second wireless slave machine transmits the third authentication information acquired by the external information acquisition unit to the wireless master machine. The wireless master machine sets the received third authentication information to the second authentication information. The first wireless slave machine acquires the first network authentication information from the first wireless slave machine after associating with the second network using the third authentication information. The first wireless slave machine associates with the first network using the received first network authentication information.

### TECHNICAL FIELD

The present invention relates to a wireless communication system, a non-transitory computer-readable medium storing a connection authentication program, and a connection authentication method, and more particularly, to a wireless communication system, a connection authentication program, and a connection authentication method which cause a new terminal to associate with a network by radio communication.

### BACKGROUND ART

In order to connect a wireless master machine (hereinafter referred to as a master machine) and a wireless slave machine (hereinafter referred to as a slave machine) to each other, it is necessary to set profile information (an SSID, an encryption mode, an encryption key) for identifying the network of the master machine to the slave machine. Further, the slave machine searches the SSID of the master machine to be connected from the profile information set in the slave machine, and performs connection authentication upon finding of the master machine to be connected. When the authentication is successful, the connection between the slave machine and the master machine is completed.

To set the profile information of the mater machine to the slave machine, the following methods are used. That is, a method of delivering a profile by pressing buttons installed in the slave machine and the master machine like in a push-button system of WPS (Wi-Fi Protected Setup), and a method of accessing a user interface of the slave machine using a personal computer and manually inputting profile information to the slave machine.

In this regard, Patent Literature 1 discloses a method for delivering profile information of a master machine to a slave machine. A radio communication device disclosed in Patent Literature 1 stores BSSID of an access point into a memory when a first radio connection is established. Further, the radio communication device receives two Probe Responses from two access points when the first radio connection is disconnected due to a change of the SSID of the access point to a different SSID. Then, the radio communication device specifies the Probe Responses including the BSSID of the access point, which is a connection counterpart of the first radio connection, from the two Probe Responses by using the BSSID stored in the memory. This radio communication device establishes a second radio connection with the access point, which is the connection counterpart of the first radio connection, by using the SSID included in the specified Probe Responses.

### CITATION LIST

### Patent Literature

### Japanese Unexamined Patent Application Publication No. 2013-74579

### SUMMARY OF INVENTION

### Technical Problem

However, in the technique disclosed in Patent Literature 1, the establishment of at least one connection between the slave machine and the master machine need to be completed. Therefore, even if the technique disclosed in Patent Literature 1 is used, there is a problem that when a new terminal is connected to the network of the master machine, it is necessary to use WPS, or it is necessary to manually set profile information of the master machine to the slave machine.

### Solution to Problem

One aspect of the present invention is a wireless communication system including: a wireless master machine configured to control communication between slave machines or between a slave machine and an upper network in each of a first network that performs connection authentication of a slave machine based on first authentication information and a second network that performs connection authentication of a slave machine based on second authentication information; a first wireless slave machine including third authentication information used for connection to a third network; and a second wireless slave machine including external information acquisition unit configured to associate with the first network and acquire the third authentication information. The second wireless slave machine causes the external information acquisition unit to acquire the third authentication information and transmits the acquired third authentication information to the wireless master machine via the first network. The wireless master machine sets the third authentication information received via the first network to the second authentication information, and the first wireless slave machine transmits the first authentication information to the first wireless slave machine after the first wireless slave machine associates with the second network using the third authentication information. The first wireless slave machine associates with the first network using the first authentication information received via the second network.

Another aspect of the present invention is a non-transitory computer-readable medium storing a connection authentication program executed in a wireless communication system including: a wireless master machine configured to control communication between slave machines or between a slave machine and an upper network in each of a first network that performs connection authentication of a slave machine based on first authentication information and a second network that performs connection authentication of a slave machine based on second authentication information; a first wireless slave machine including third authentication information used for connection to a third network; and a second wireless slave machine including an external information acquisition unit configured to associate with the first network and acquire the third authentication information, the connection authentication program including: a new terminal information transfer program to be executed in the second wireless slave machine, the new terminal information transfer program being configured to cause the external information acquisition unit to acquire the third authentication information and transmit the acquired third authentication information to the wireless master machine via the first network; an associated network information transfer program to be executed in the wireless master machine, the associated network information transfer program being configured to set the third authentication information received via the first network to the second authentication information and transmit the first authentication information to the first wireless slave machine after the first wireless slave machine associates with the second network using the third authentication information; and an associated network switch program to be executed in the first wireless slave machine, the associated network switch program being configured to cause the first wireless slave machine to associate with the first network using the first authentication information received via the second network.

Still another aspect of the present invention is a connection authentication method of a wireless communication system including: a wireless master machine configured to control communication between slave machines or between a slave machine and an upper network in each of a first network that performs connection authentication of a slave machine based on first authentication information and a second network that performs connection authentication of a slave machine based on second authentication information; a first wireless slave machine including third authentication information used for connection to a third network; and a second wireless slave machine including an external information acquisition unit configured to associate with the first network and acquire the third authentication information, the connection authentication method including: acquiring the third authentication information by the external information acquisition unit of the second wireless slave machine; transmitting the third authentication information acquired by the second wireless slave machine to the wireless master machine via the first network; setting, in the wireless master machine, the third authentication information received via the first network to the second authentication information; transmitting, by the wireless master machine, the first authentication information to the first wireless slave machine after the first wireless slave machine associates with the second network using the third authentication information; making a request for association with the first network using the first authentication information received by the first wireless slave machine via the second network; and authenticating association of the second wireless slave machine with the first network in response to the association request.

### Advantageous Effects of Invention

According to a wireless communication system, a connection authentication program, and a connection authentication method of the present invention, it is possible to authenticate a new terminal network connection with a simple method without using a physical push button or the like.

### BRIEF DESCRIPTION OF DRAWINGS

FIG. 1 is a block diagram showing a wireless communication system according to a first embodiment;

FIG. 2 is a block diagram showing a wireless master machine according to the first embodiment;

FIG. 3 is a block diagram showing a first wireless slave machine according to the first embodiment;

FIG. 4 is a block diagram showing a second wireless slave machine according to the first embodiment;

FIG. 5 is a sequence diagram for explaining an operation of the wireless communication system according to the first embodiment;

FIG. 6 is a block diagram showing a wireless communication system according to a second embodiment;

FIG. 7 is a block diagram showing a first wireless slave machine according to the second embodiment;

FIG. 8 is a block diagram showing a second wireless slave machine according to the second embodiment; and

FIG. 9 is a sequence diagram for explaining an operation of the wireless communication system according to the second embodiment.

### DESCRIPTION OF EMBODIMENTS

### First Embodiment

Hereinafter, embodiments of the present invention will be described with reference to the drawings. For clarity of explanation, the following description and the drawings are abbreviated or simplified as appropriate. In the drawings, the same elements are denoted by the same reference numerals, and repeated descriptions are omitted as needed.

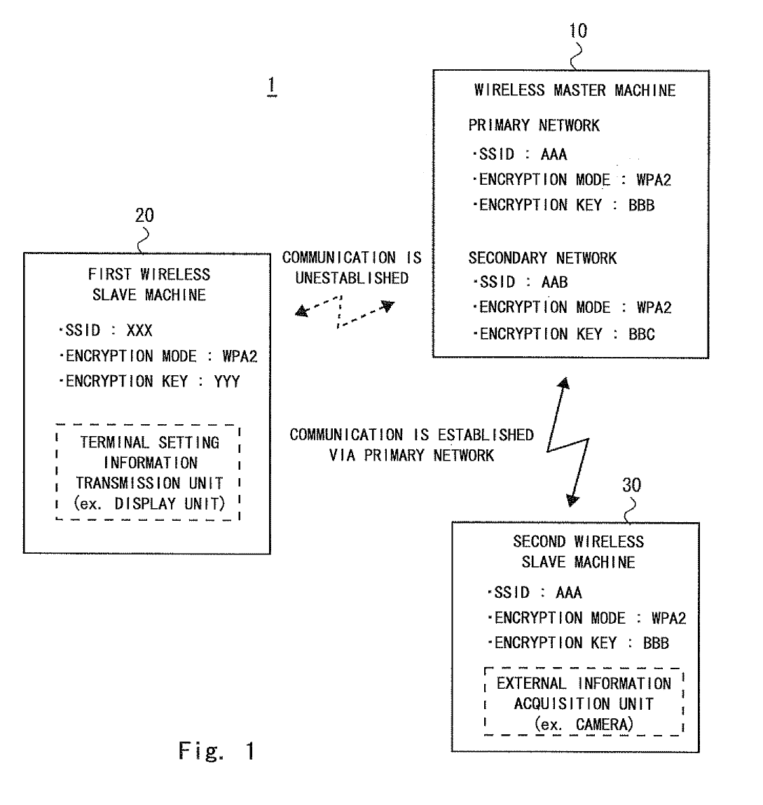

FIG. 1 shows a block diagram of a wireless communication system 1 according to a first embodiment. As shown in FIG. 1, the wireless communication system 1 includes a wireless master machine 10, a first wireless slave machine 20, and a second wireless slave machine 30. In the wireless communication system 1, the wireless master machine 10 has a function for constructing a first network (e.g., a primary network) and a second network (e.g., a secondary network). Assume that a connection is established between the second wireless slave machine 30 and the second wireless master machine 10 in the primary network. In a connection authentication method in the wireless communication system 1 according to the first embodiment, the wireless slave machine 20 is caused to associate with the primary network, without operating a hardware button, such as WPS, for the first wireless slave machine 20 which has never been connected to the primary network, or without performing manual setting for the first wireless slave machine 20.

Note that the wireless master machine 10, the first wireless slave machine 20, and the second wireless slave machine 30 each include a processing unit. Each processing unit executes a program to thereby perform processing for authenticating the first wireless slave machine 20 to associate with the primary network. This connection authentication program includes an associated network information transfer program to be executed by the wireless master machine 10, an associated network switch program to be executed by the first wireless slave machine 20, and a new terminal information transfer program to be executed by the second wireless slave machine 30. Assume that the operation (e.g., processing shown in FIGS. 5 and 9 and the like) of each device described below is implemented by a program executed by each device.

The above-mentioned program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line, such as an electric wire and an optical fiber, or a wireless communication line.

The wireless master machine 10 controls communication between slave machines or between a slave machine and an upper network in each of the primary network that performs connection authentication of the slave machine based on first authentication information and a secondary network that performs connection authentication of a slave machine based on second authentication information. The first authentication information is stored in the wireless master machine 10 as profile information of the primary network. In the example shown in FIG. 1, the profile information of the primary network includes AAA which is set as SSID; WPA2 which is set as an encryption mode; and BBB which is set as an encryption key. The second authentication information is stored in the wireless master machine 10 as profile information of the secondary network. In the example shown in FIG. 1, the profile information of the secondary network includes AAB which is set as SSID; WPA2 which is set as an encryption mode; and BBC which is set as an encryption key.

When the wireless master machine 10 receives third authentication information about the first wireless slave machine 20 from the second wireless slave machine 30 via the primary network, the wireless master machine overwrites the profile information of the secondary network with the third authentication information. Further, the wireless master machine 10 transmits the profile information of the primary network to the first wireless slave machine 20 after the first wireless slave machine 20 associates with the secondary network using the third authentication information.

The first wireless slave machine 20 includes the third authentication information used for connection to a third network. The first wireless slave machine 20 is a new terminal which has never been connected to the primary network of the wireless master machine 10. In the first embodiment, the third authentication information is the profile information of the third network which is different from that of the primary network and the secondary network of the wireless master machine 10. In the example shown in FIG. 1, the third authentication information includes XXX which is set as SSID; WPA2 which is set as an encryption mode; and YYY which is set as an encryption key. The third authentication information is the profile information of a temporary network set to the first wireless slave machine. The third authentication information need not necessarily be network information that actually exists. The first wireless slave machine 20 includes a terminal setting information transmission unit that displays the third authentication information as image information.

The first wireless slave machine 20 has an associated network switching function for associating with the primary network using the profile information when the profile information of the primary network from the wireless mater machine via the secondary network which is started by the wireless master machine 10 using the third authentication information is received.

The second wireless slave machine 30 includes an external information acquisition unit that associates with the primary network and acquires the third authentication information. The second wireless slave machine 30 includes the first authentication information (e.g., the profile information of the primary network) for associating with the primary network. Therefore, the first wireless slave machine 20 can associate with the primary network of the wireless master machine 10 by using the profile information included in the first wireless slave machine. Further, the second wireless slave machine 30 has a function for causing the external information acquisition unit to acquire the third authentication information of the first wireless slave machine 20, and transferring the acquired third authentication information to the wireless master machine 10.

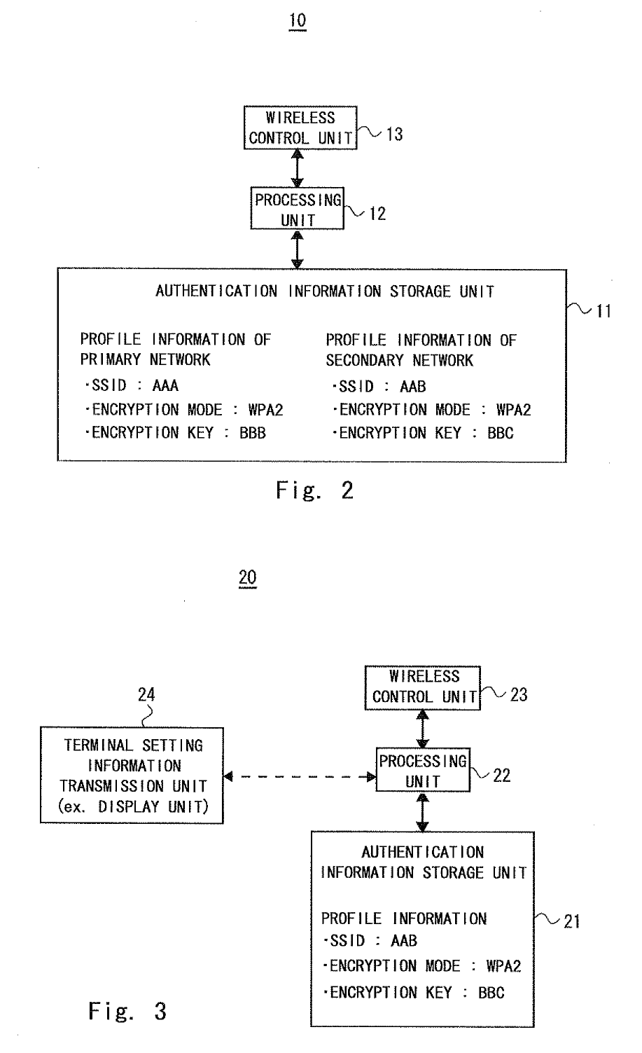

Next, detailed configurations of the wireless master machine 10, the first wireless slave machine 20, and the second wireless slave machine 30 will be described. First, FIG. 2 shows a block diagram of the wireless master machine 10 according to the first embodiment.

As shown in FIG. 2, the wireless master machine 10 according to the first embodiment includes an authentication information storage unit 11, a processing unit 12, and a wireless control unit 13. The authentication information storage unit 11 is a storage unit for storing profile information. The wireless control unit 13 stores the profile information of the primary network and the profile information of the secondary network. In this case, the profile information of the secondary network is temporary profile information. The content of the profile is overwritten by executing the associated network information transfer program. Note that setting of the profile information of the secondary network may be omitted. The authentication information storage unit 11 stores not only information about setting of the configuration (network name, encryption mode, and encryption key) of the network itself, but also information about the associated slave machine.

The processing unit 12 executes the associated network transfer program. Further, the processing unit 12 implements various functions, such as an authentication function, a router function, and a filter function, which are implemented in the wireless master machine 10. The wireless control unit 13 is a radio interface that performs communication with the slave machine. The wireless control unit 13 reports the network information of the wireless control unit 13 itself, or broadcasts radio packets called beacons at predetermined intervals so that the associated slave machine continuously associates with the network. A plurality of beacons are transmitted in the same radio channel, thereby making it possible to virtually construct a plurality of radio networks in the same channel. In the wireless master machine 10, in addition to the primary network serving as a main network, a secondary network is constructed as a sub network. The secondary network serving as a sub network disables a part of the functions, for example, so as to maintain the security, thereby making it possible to limit the services to be provided, as compared with the primary network.

Next, FIG. 3 shows a block diagram of the first wireless slave machine 20 according to the first embodiment. As shown in FIG. 3, the first wireless slave machine 20 according to the first embodiment includes an authentication information storage unit 21, a processing unit 22, a wireless control unit 23, and a terminal setting information transmission unit 24.

The authentication information storage unit 21 stores the third authentication information. Further, the profile information of the primary network is added to the authentication information storage unit 21 by the associated network switch program.

The processing unit 22 executes the associated network switch program. Further, the processing unit 22 implements various functions, such as the authentication function and the information processing function, which are implemented in the first wireless slave machine 20. The wireless control unit 23 is a radio interface that performs communication with the master machine.

The terminal setting information transmission unit 24 is a display unit that displays image information about the third authentication information stored in the authentication information storage unit 21. The terminal setting information transmission unit 24 may be, for example, a display, the content of which can be changed, or a printed matter associated with the first wireless slave machine 20. When a display is used as the terminal setting information transmission unit 24, the image information about the third authentication information that is read out from the authentication information storage unit 21 by the processing unit 22 is displayed. When a printed matter is used as the terminal setting information transmission unit 24, there is no need for the terminal setting information transmission unit 24 to be connected to the processing unit 22. As the image information, a two-dimensional barcode, a one-dimensional barcode, an image used to directly display the third authentication information, and the like can be used. Note that the third authentication information to be displayed may be encrypted, or may be a plain text.

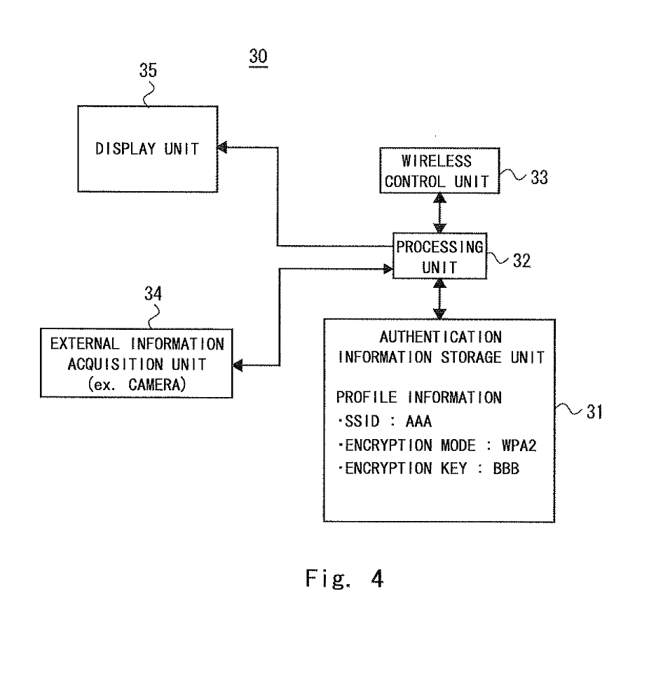

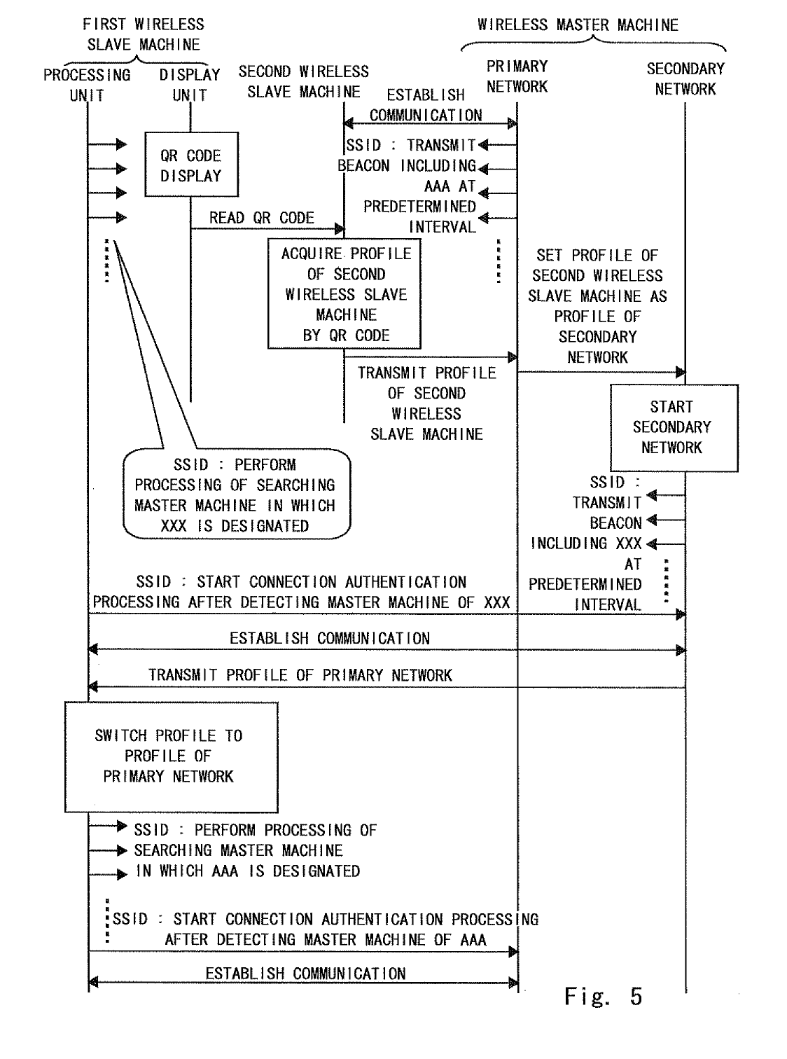

Next, FIG. 4 shows a block diagram of the second wireless slave machine 30 according to the first embodiment. As shown in FIG. 4, the second wireless slave machine 30 according to the first embodiment includes an authentication information storage unit 31, a processing unit 32, a wireless control unit 33, an external information acquisition unit 34, and a display unit 35.

The authentication information storage unit 31 stores the profile information of the primary network. The processing unit 32 executes the new terminal information transfer program. Further, the processing unit 32 implements various functions, such as the authentication function and the information processing function, which are implemented in the second wireless slave machine 30. The wireless control unit 33 is a radio interface that performs communication with the master machine. The display unit 35 displays a user interface for operating the second wireless slave machine 30 for a user who operates the second wireless slave machine 30.

The external information acquisition unit 34 is a block that acquires the third authentication information, and a camera or the like can be used in the first embodiment. The second wireless slave machine 30 extracts the third authentication information from the image information acquired by the external information acquisition unit 34, and transfers the extracted information to the wireless master machine 10.

Next, the operation of the wireless communication system 1 according to the first embodiment will be described. In this regard, FIG. 5 shows a sequence diagram for explaining the operation of the wireless communication system 1 according to the first embodiment. As shown in FIG. 5, in the wireless communication system 1 according to the first embodiment, the second wireless slave machine 30 is caused to associate with the primary network of the wireless master machine 10 before the first wireless slave machine 20 is caused to associate with the primary network of the wireless master machine 10.

Next, processing for causing the first wireless slave machine 20 to associate with the primary network of the wireless master machine 10 is executed. This processing is executed by the connection authentication program which is configured using a program implemented in each device in the wireless communication system 1.

First, the first wireless slave machine 20 executes a master machine search based on the third authentication information. In this master machine search, the master machine in which XXX is set as SSID is searched at predetermined intervals based on the third authentication information. Further, the first wireless slave machine 20 displays the image information (e.g., a two-dimensional barcode) on the terminal setting information transmission unit 24. The wireless master machine 10 transmits by broadcast beacons using AAA set as SSID based on the profile information of the primary network so as to notify the surroundings of the presence of the wireless master machine 10.

Next, image acquisition processing using the external information acquisition unit 34 is executed by the new terminal information transfer program of the second wireless slave machine 30. The second wireless slave machine 30 acquires the third authentication information from the acquired image information. Further, the second wireless slave machine 30 transmits the acquired third authentication information to the wireless master machine 10 via the primary network.

Next, the wireless master machine 10 starts the associated network information transfer program. The associated network information transfer program causes the third authentication information received via the primary network to be set as the profile information of the secondary network and starts the secondary network. After that, the wireless master machine 10 transmits the beacons in which XXX is designated as SSID at predetermined intervals based on the profile information of the secondary network. Assume that the transmission of beacons related to the secondary network and the transmission of beacons related to the primary network are performed in parallel.

Thus, in the wireless communication system 1, the first wireless slave machine 20 detects the secondary network of the wireless master machine 10 as a network with which the wireless communication system 1 can associate. According to the detection result, connection authentication processing for allowing the first wireless slave machine 20 to associate with the secondary network of the wireless master machine 10 is started. When the connection authentication processing is successful, the first wireless slave machine 20 associates with the secondary network of the wireless master machine 10. After that, the wireless master machine 10 transmits the profile information of the primary network to the first wireless slave machine 20.

Upon receiving the profile information of the primary network from the wireless master machine 10, the first wireless slave machine 20 disconnects the connection with the secondary network of the wireless master machine 10 based on the third authentication information by the associated network switch program, and attempts to establish a connection based on the profile information of the primary network. As a result, the first wireless slave machine 20 performs the master machine search in which AAA is designated as SSID based on the profile information of the primary network. When the first wireless slave machine 20 detects the primary network of the wireless master machine 10, the connection authentication processing for allowing the first wireless slave machine 20 to associate with the secondary network of the wireless master machine 10 is started. When the connection authentication processing is successful, the first wireless slave machine 20 associates with the primary network of the wireless master machine 10.

As described above, in the wireless communication system 1 according to the first embodiment, the profile information of the network with which the wireless master machine 10 can associate is transmitted to the wireless master machine 10 by using the second wireless slave machine 30. The profile information is presented in the image information by the first wireless slave machine 20. Further, in the, wireless communication system 1, the wireless master machine 10 temporarily constructs a network with which the first wireless slave machine 20 can associate, and transfers the profile information of the primary network, which is a network to be originally connected, from the wireless master machine 10 to the first wireless slave machine 20. Thus, the wireless communication system 1 enables the first wireless slave machine 20 to newly associate with the primary network of the wireless master machine 10 without pressing physical buttons or performing manual setting for the wireless master machine 10.

In recent years, radio communication functions are mounted on various devices. In particular, it may be difficult to load a user interface for providing a WPS button or a radio communication setting screen in small devices. Also in this case, the use of the wireless communication system 1 according to the first embodiment enables a new radio communication device to associate with an existing network. In particular, in the wireless communication system 1 according to the first embodiment, the third authentication information, which is originally given to a device to be newly involved in the network, can be provided using a printed matter or the like which is separate from the device body. This facilitates miniaturization of the device.

Further, the wireless master machine 10 is often installed in a location beyond the reach of the user's hand. In this case, it is difficult to operate a physical interface, such as a WPS button, which is provided in the wireless master machine 10. However, the use of the wireless communication system 1 according to the first embodiment eliminates the need for operating the physical interface provided in the wireless master machine 10, so that the authentication processing for allowing the slave machine to associate with a new terminal can be facilitated, while the degree of freedom of installation of the wireless is improved.

The use of the wireless communication system 1 according to the first embodiment improves the network security. More specifically, when a connection permission function using a physical button is implemented in the wireless master machine 10, an unauthorized intruder can penetrate the network using the button. However, in the wireless communication system 1 according to the first embodiment, the wireless master machine 10 can delete the connection authentication function using the physical button. Thus, the wireless communication system 1 according to the first embodiment can improve the network security.

### Second Embodiment

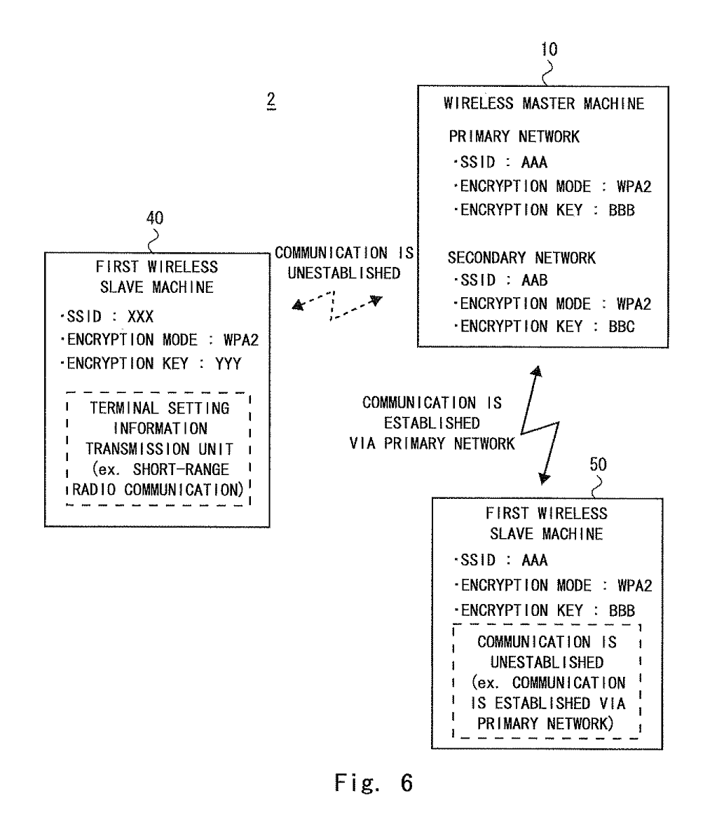

In a second embodiment, another mode of the connection authentication method for the wireless communication system 1 according to the first embodiment will be described. In this regard, FIG. 6 shows a block diagram of a wireless communication system 2 according to the second embodiment.

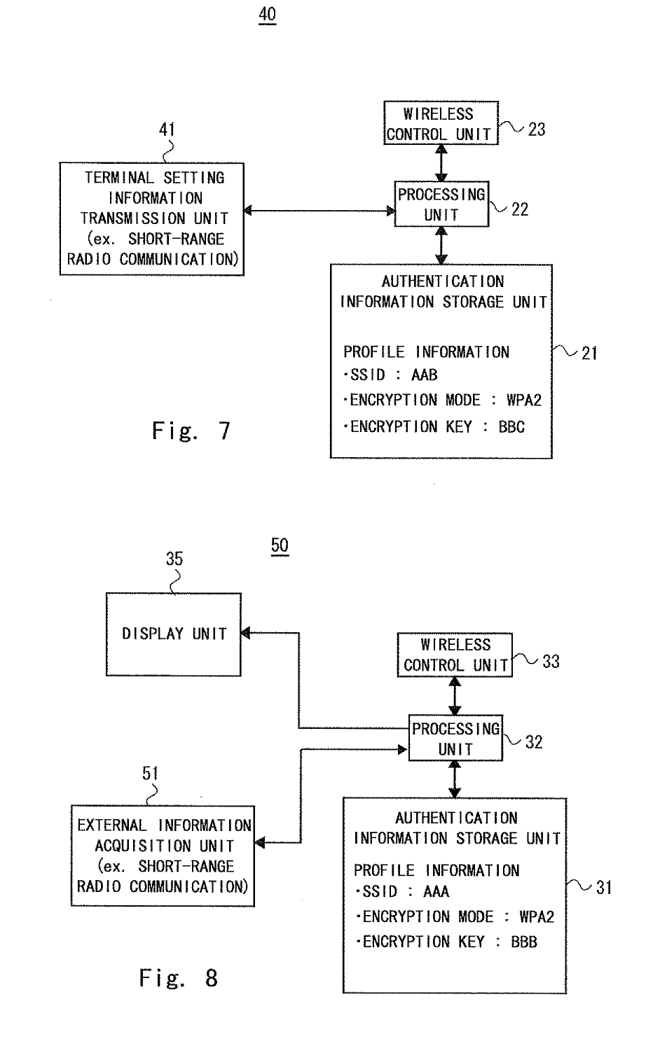

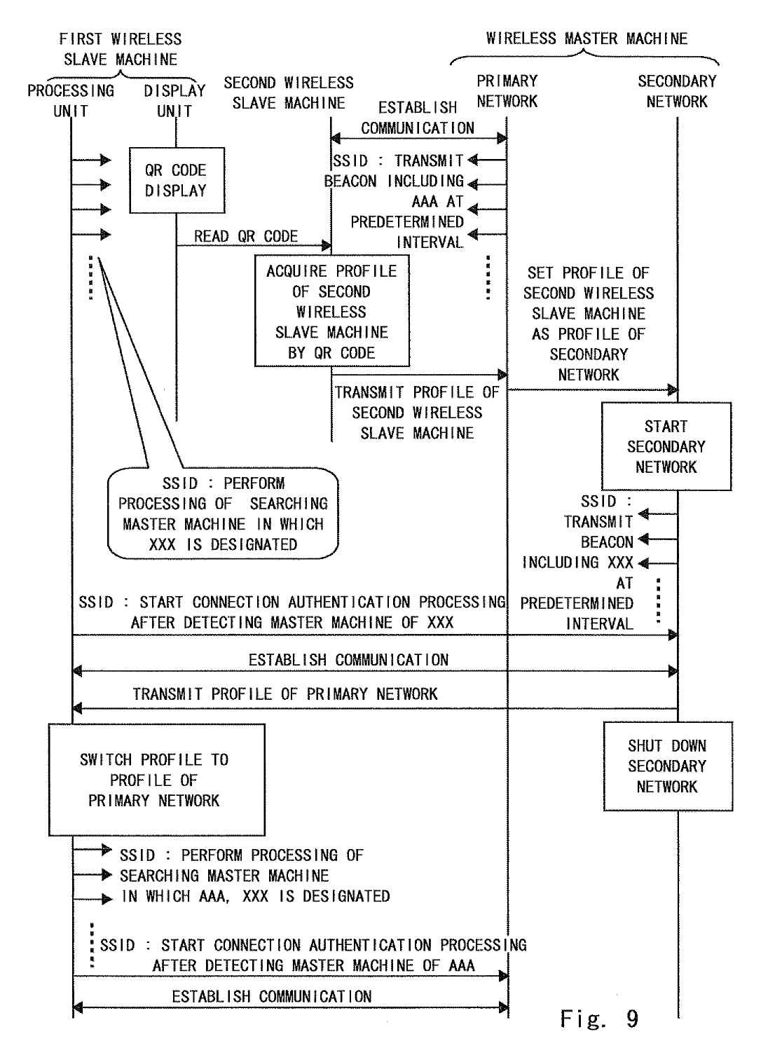

As shown in FIG. 6, the wireless communication system 2 according to the second embodiment includes a first wireless slave machine 40 and a second wireless slave machine 50 instead of the first wireless slave machine 20 and the second wireless slave machine 30. The first wireless slave machine 40 has a function for transferring the third authentication information by short-range radio communication. The second wireless slave machine 50 has a function for receiving the third authentication information from the first wireless slave machine 40 by short-range radio communication. In this regard, FIG. 7 shows a block diagram of the first wireless slave machine 40, and FIG. 8 shows a block diagram of the second wireless slave machine 50.

As shown in FIG. 7, the first wireless slave machine 40 includes a terminal setting information transmission unit 41 instead of the terminal setting information transmission unit 24. The terminal setting information transmission unit 41 is a communication interface capable of performing short-range radio communication such as NFC (Near Field Communication) standard and Bluetooth®. The first wireless slave machine 40 causes the processing unit 22 to read out the third authentication information stored in the third authentication information stored in the authentication information storage unit 21, and transmits the third authentication information via the terminal setting information transmission unit 41.

As shown in FIG. 8, the second wireless slave machine 50 includes an external information acquisition unit 51 instead of the external information acquisition unit 34. The external information acquisition unit 51 is a communication interface that performs communication using the same communication standard as that of the terminal setting information transmission unit 41. The second wireless slave machine 50 transfers the third authentication information acquired from the first wireless slave machine 40 via the external information acquisition unit 51 to the wireless master machine 10.

Next, the operation of the wireless communication system 2 according to the second embodiment will be described. FIG. 9 shows a sequence diagram for explaining the operation of the wireless communication system 2 according to the second embodiment. As shown in FIG. 9, the wireless communication system 2 according to the second embodiment differs from the wireless communication system 1 according to the first embodiment in that the transfer of the third authentication information from the first wireless slave machine 40 to the second wireless slave machine 50 is performed by radio communication. However, except for this difference, the processing for transferring the third authentication information from the first wireless slave machine 40 to the wireless master machine 10 and transmitting the profile of the primary network to the wireless master machine 10 via the secondary network in the wireless communication system 2 according to the second embodiment is the same as that of the wireless communication system 1 according to the first embodiment.

On the other hand, the wireless communication system 2 according to the second embodiment differs from the wireless communication system 1 according to the first embodiment in regard to the operation performed after the profile of the primary network is transmitted to the wireless master machine 10 via the secondary network.

Specifically, in the wireless communication system 2 according to the second embodiment, the wireless master machine 10 shuts down the secondary network after transmitting the profile of the primary network to the wireless mater machine 10 via the secondary network. As a result, the communication between the wireless master machine 10 and the secondary network of the first wireless slave machine 40 is disconnected.

Upon receiving the profile of the primary network, the first wireless slave machine 40 according to the second embodiment adds the profile information of the primary network to the authentication information storage unit 21. Further, the first wireless slave machine 40 performs the master machine search based on both the profile information of the primary network and the third authentication information. In other words, the first wireless slave machine 40 performs the master machine search in which AAA is designated as SSID and the master machine search in which XXX is designated as SSID in parallel. Further, since in the wireless communication system 2 according to the second embodiment, the secondary network of the wireless master machine 10 is shut down, the first wireless slave machine 40 can find the primary network of the wireless master machine 10 and associate with the primary network.

As described above, in the wireless communication system 2 according to the second embodiment, the delivery of the third authentication information from the first wireless slave machine 40 to the second wireless slave machine 50 by short-range radio communication can be achieved. The delivery of the third authentication information by short-range radio communication makes it possible to reduce security risks due to, for example, leakage of information on the printed matter.

Further, in the wireless communication system 2 according to the second embodiment, the third authentication information held by the first wireless slave machine 40 is transferred to the second wireless slave machine 50 by short-range radio communication. Thus, the wireless communication system 2 according to the second embodiment is capable of holding newly received profile information of the primary network without deleting the third authentication information of the first wireless slave machine 40, and is also capable of reusing the third authentication information in the authentication processing for other networks.

Note that the function for holding newly received profile information of the primary network without deleting the third authentication information of the first wireless slave machine 40 can also be applied to the first wireless slave machine 20 according to the first embodiment. Consequently, the printed matter or image information associated with the wireless master machine 10 according to the first embodiment can be reused in the authentication processing for other networks.

Note that the present invention is not limited to the above embodiments and can be modified as appropriate without departing from the scope of the invention.

This application is based upon and claims the benefit of priority from Japanese patent application No. 2014-237974, filed on Nov. 25, 2014, the disclosure of which is incorporated herein in its entirety by reference.

### REFERENCE SIGNS LIST

1 WIRELESS COMMUNICATION SYSTEM
2 WIRELESS COMMUNICATION SYSTEM
10 WIRELESS MASTER MACHINE
11 AUTHENTICATION INFORMATION STORAGE UNIT
12 PROCESSING UNIT
13 WIRELESS CONTROL UNIT
20 FIRST WIRELESS SLAVE MACHINE
21 AUTHENTICATION INFORMATION STORAGE UNIT
22 PROCESSING UNIT
23 WIRELESS CONTROL UNIT
24 TERMINAL SETTING INFORMATION TRANSMISSION UNIT
30 SECOND WIRELESS SLAVE MACHINE
31 AUTHENTICATION INFORMATION STORAGE UNIT
32 PROCESSING UNIT
33 WIRELESS CONTROL UNIT
34 EXTERNAL INFORMATION ACQUISITION UNIT
35 DISPLAY UNIT
40 FIRST WIRELESS SLAVE MACHINE
41 TERMINAL SETTING INFORMATION TRANSMISSION UNIT
50 SECOND WIRELESS SLAVE MACHINE
51 EXTERNAL INFORMATION ACQUISITION UNIT

What is claimed is:

1. A wireless communication system comprising:
a wireless master machine configured to control communication between slave machines or between a slave machine and an upper network in each of a first network that performs connection authentication of a slave machine based on first authentication information and a second network that performs connection authentication of a slave machine based on second authentication information;
a first wireless slave machine including third authentication information used for connection to a third network; and
a second wireless slave machine including external information acquisition means for associating with the first network and acquiring the third authentication information, wherein
the second wireless slave machine causes the external information acquisition means to acquire the third authentication information and transmits the acquired third authentication information to the wireless master machine via the first network,
the wireless master machine sets the third authentication information received via the first network to the second authentication information, and the first wireless slave machine transmits the first authentication information to the first wireless slave machine after the first wireless slave machine associates with the second network using the third authentication information, and
the first wireless slave machine associates with the first network using the first authentication information received via the second network.

2. The wireless communication system according to claim 1, wherein
the third authentication information is displayed using image information capable of transmitting information, and
the external information acquisition means acquires the third authentication information from the image information.

3. The wireless communication system according to claim 1, wherein the external information acquisition means acquires the third authentication information by short-range radio communication.

4. The wireless communication system according to claim 1, wherein the first wireless slave machine cancels the association with the second network after receiving the first authentication information, and performs a master machine search based on the first authentication information.

5. The wireless communication system according to claim 1, wherein
the wireless master machine shuts down the second network after transmitting the first authentication information to the second wireless slave machine, and
the first wireless slave machine performs a master machine search using the third authentication information, and performs a master machine search using the first authentication information.

6. A non-transitory computer-readable medium storing a connection authentication program executed in a wireless communication system including:
a wireless master machine configured to control communication between slave machines or between a slave machine and an upper network in each of a first network that performs connection authentication of a slave machine based on first authentication information and a second network that performs connection authentication of a slave machine based on second authentication information;
a first wireless slave machine including third authentication information used for connection to a third network; and
a second wireless slave machine including external information acquisition means for associating with the first network and acquiring the third authentication information,
the connection authentication program comprising:
a new terminal information transfer program to be executed in the second wireless slave machine, the new terminal information transfer program being configured to cause the external information acquisition means to acquire the third authentication information and transmit the acquired third authentication information to the wireless master machine via the first network;
an associated network information transfer program to be executed in the wireless master machine, the associated network information transfer program being configured to set the third authentication information received via the first network to the second authentication information and transmit the first authentication information to the first wireless slave machine after the first wireless slave machine associates with the second network using the third authentication information; and
an associated network switch program to be executed in the first wireless slave machine, the associated network switch program being configured to cause the first wireless slave machine to associate with the first network using the first authentication information received via the second network.

7. A connection authentication method of a wireless communication system including:
a wireless master machine configured to control communication between slave machines or between a slave machine and an upper network in each of a first network that performs connection authentication of a slave machine based on first authentication information and a second network that performs connection authentication of a slave machine based on second authentication information;
a first wireless slave machine including third authentication information used for connection to a third network; and
a second wireless slave machine including external information acquisition means for associating with the first network and acquiring the third authentication information,
the connection authentication method comprising:
acquiring the third authentication information by the external information acquisition means of the second wireless slave machine;
transmitting the third authentication information acquired by the second wireless slave machine to the wireless master machine via the first network;
setting, in the wireless master machine, the third authentication information received via the first network to the second authentication information;
transmitting, by the wireless master machine, the first authentication information to the first wireless slave machine after the first wireless slave machine associates with the second network using the third authentication information;
making a request for association with the first network using the first authentication information received by the first wireless slave machine via the second network; and
authenticating association of the second wireless slave machine with the first network in response to the association request.
